(19) United States
(12) Patent Application Publication
(10) Pub. No.: US 2007/0182328 A1
(43) Pub. Date: Aug. 9, 2007

(54) Plasma display panel

(76) Inventors: Jae-Ik Kwon, Suwon-si (KR); Won-Ju Yi, Suwon-si (KR); Ho-Young Ahn, Suwon-si (KR); Kyoung-Doo Kang, Suwon-si (KR); Soo-Ho Park, Suwon-si (KR); Seok-Gyun Woo, Suwon-si (KR)

Correspondence Address: LEE & MORSE, P.C., 3141 FAIRVIEW PARK DRIVE, SUITE 500, FALLS CHURCH, VA, 22042, US

(21) Appl. No.: 11/702,226

(22) Filed: Feb. 5, 2007

(30) Foreign Application Priority Data
Feb. 7, 2006 (KR) 10-2006-0011747

(51) Int. Cl. H01J 17/49

(52) U.S. Cl. 313/582; 313/587

(57) ABSTRACT

A plasma display panel (PDP) includes a first substrate having a plurality of roughened portions, a second substrate spaced apart from the first substrate, a plurality of barrier ribs dividing a space between the first substrate and the second substrate into a plurality of discharge cells, the barrier ribs positioned between the second substrate and a respective roughened portion of the first substrate, and a plurality of first and second discharge electrodes disposed inside the electrode sheet.

### BACKGROUND OF THE INVENTION

1. Field of the Invention

The present invention relates to a plasma display panel. In particular, the present invention relates to a plasma display panel having reduced reflection brightness.

2. Description of the Related Art

In general, a plasma display panel (PDP) refers to a display panel capable of displaying images using gas discharge phenomenon, thereby providing superior display characteristic, such as high brightness and contrast, lack of residual image, and wide viewing angles.

The conventional PDP may include two substrates with a plurality of discharging electrodes therebetween, i.e., a plurality of pairs of sustain electrodes, discharging gases injected into predefined spaces between the substrates, barrier ribs between the two substrates to divide a space between the two substrates into a plurality of discharge cells, and phosphorescent layers. When a predetermined amount of electricity is applied to the discharging electrodes, a sustain discharge may be generated in the discharge cells to trigger ultraviolet (UV) emission and, thereby, to excite the phosphorescent layers to emit light and form images.

However, the pluralities of pairs of sustain electrodes in the conventional PDP are often disposed on the first substrate. Such sustain electrodes configuration may provide a sustain discharge only in a horizontal direction along the first substrate and transmit a reduced amount of visible light. Further, the barrier ribs in the conventional PDP may reflect some of the visible light and, thereby, increase the reflection brightness of the PDP. Increase of reflection brightness may reduce contrast and deteriorate the overall PDP quality.

Accordingly, there exists a need to improve the structure of the PDP in order to minimize its reflection brightness and maximize the visible light transmitted therethrough.

### SUMMARY OF THE INVENTION

It is a feature of an embodiment of the present invention to provide a plasma display panel exhibiting minimized reflection brightness.

It is another feature of an embodiment of the present invention to provide a plasma display panel providing improved visible light transmittance.

The present invention provides a plasma display panel (PDP), including a first substrate having a plurality of roughened portions, a second substrate spaced apart from the first substrate, a plurality of barrier ribs dividing a space between the first substrate and the second substrate into a plurality of discharge cells, the barrier ribs positioned between the second substrate and a respective roughened portion of the first substrate, and a plurality of first and second discharge electrodes disposed inside the electrode sheet.

The first substrate may include a plurality of grooves, wherein each groove may be positioned between two adjacent roughened portions.

The PDP may further include a plurality of phosphor layers, wherein each phosphor layer may be disposed on a surface of a respective groove. Further, each phosphor layer may be positioned between a respective discharge cell and a respective groove.

Each of the plurality of first and second discharge electrodes may include a plurality of shapes surrounding each of the discharge cells. Each such shape may be a circle. Each of the plurality of the first discharge electrodes may be parallel to one another and each of the plurality of the second discharge electrodes may be parallel to one another, wherein the plurality of first discharge electrodes may be positioned on a plane parallel to a plane of the second discharge electrodes. Further, the pluralities of the first and second discharge electrodes may be positioned to align each respective tangential circle thereof around a respective discharge cell.

Each of the plurality of the first discharge electrodes may cross the plurality of the second discharge electrodes. Alternatively, each of the plurality of the first discharge electrodes may extend in a direction parallel to a direction of the plurality of the second discharge electrodes, wherein the PDP may further include a plurality of address electrodes positioned on a plane parallel to the planes of the first and second discharge electrodes and extend in a direction perpendicular to the directions of the first and second discharge electrodes.

The roughened portions may be parallel to the barrier rib portions. Additionally, the barrier rib portions may include a dielectric material.

### BRIEF DESCRIPTION OF THE DRAWINGS

The above and other features and advantages of the present invention will become more apparent to those of ordinary skill in the art by describing in detail exemplary embodiments thereof with reference to the attached drawings, in which:

FIG. 1 illustrates a partially exploded perspective view of a PDP according to an embodiment of the present invention;

FIG. 2 illustrates a cross-sectional view taken along line II-II of the PDP illustrated in FIG. 1;

FIG. 3 illustrates a schematic diagram of discharge cells and first and second discharge electrodes of the PDP illustrated in FIG. 1;

FIG. 4 illustrates a cross-sectional view of a PDP according to another embodiment of the present invention; and

FIG. 5 illustrates a schematic diagram of discharge cells, discharge electrodes, and address electrode of the PDP illustrated in FIG. 4.

### DETAILED DESCRIPTION OF THE INVENTION

Korean Patent Application No. 10-2006-0011747, filed on Feb. 7, 2006, in the Korean Intellectual Property Office, and entitled: “Plasma Display Panel,” is incorporated by reference herein in its entirety.

The present invention will now be described more fully hereinafter with reference to the accompanying drawings, in which exemplary embodiments of the invention are illustrated. The invention may, however, be embodied in different forms and should not be construed as limited to the embodiments set forth herein. Rather, these embodiments are provided so that this disclosure will be thorough and complete, and will fully convey the scope of the invention to those skilled in the art.

It will further be understood that when an element is referred to as being “on” another element or substrate, it can be directly on the other element or substrate, or intervening elements may also be present.

Further, it will be understood that when an element is referred to as being “under” another element, it can be directly under, or one or more intervening elements may also be present. In addition, it will also be understood that when an element is referred to as being “between” two elements, it can be the only element between the two elements, or one or more intervening elements may also be present.

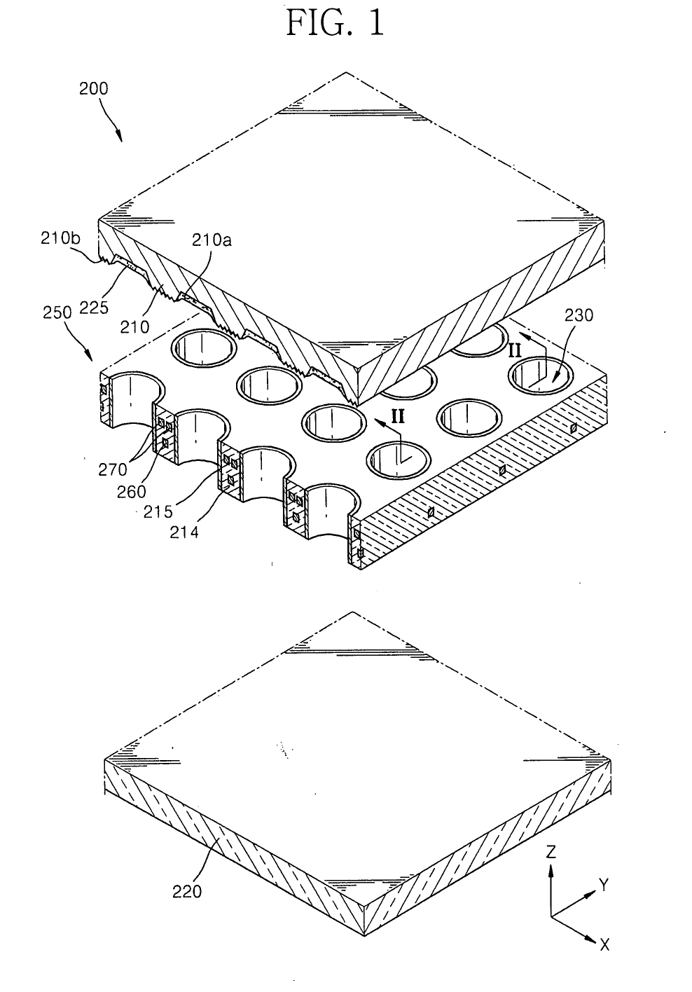

An exemplary embodiment of a plasma display device (PDP) according to the present invention is more fully described below with reference to FIGS. 1-3.

As illustrated in FIG. 1, a PDP 200 according to an embodiment of the present invention may include a first substrate 210, a second substrate 220, an electrode sheet 250 having discharging cells 230 therein, and a plurality of phosphorescent layers 225.

The first substrate 210 may be made of a material having excellent light transmitting properties, e.g., glass. Additionally, the first substrate 210 may be colored in order to reduce reflection brightness and, thereby, improve bright room contrast. Similarly, the second substrate 220 may also be colored and made of a material having excellent light transmitting properties, e.g., glass. Additionally, the first and second substrates 210 and 220 may be spaced apart from each other at a predetermined distance, such that the electrode sheet 250 may be positioned therebetween.

The first substrate 210 may include a plurality of grooves 210a and a plurality of roughened portions 210b. The plurality of grooves 210a may be formed as parallel channels along the y-axis on a surface of the first substrate 210. In particular, the grooves 210a may be formed above respective discharge cells 230, as will be discussed in more detail below. The plurality of roughened portions 210b may be formed in parallel to the plurality of grooves 210a on the surface of the first substrate 210 that is facing the electrode sheet 250. In particular, each roughened portion 210b may be formed between two grooves 210a and above a respective barrier rib portion 214, as illustrated in FIG. 1. The roughened portions 210b may be formed by any method known in the art, e.g., sand blasting.

Without intending to be bound by theory, it is believed that formation of the grooves 210a in the first substrate 210 may reduce the thickness of the first substrate 210 and, thereby, improve visible light transmission therethrough. Additionally, it is believed that formation of the roughened portions 210b in the first substrate 210 may reduce visible light reflection. In particular, rays of visible light incident on the first substrate 210 may reflect from the roughened portions 210b in different directions due to an uneven surface thereof, i.e., diffuse reflection, thereby reducing visible light reflection. It is further noted that visible light may be diffuse reflected from the roughened portions 210b more than once, i.e., scattered rays of visible light may be re-incident on the roughened portions 210b, thereby reducing reflection further.

The electrode sheet 250 of the PDP 200 according to an embodiment of the present invention may include barrier rib portions 214, a plurality of discharge cells 230, and a plurality of pairs of first and second discharge electrodes 260 and 270, respectively. In particular, the electrode sheet 250 may be formed as a barrier layer having a plurality of rib portions 214 configured to form discharge cells 230 therebetween. The discharge cells 230 formed between the barrier rib portions 214 may be configured to extend through the electrode sheet 250, i.e., along the z-axis, as illustrated in FIG. 1

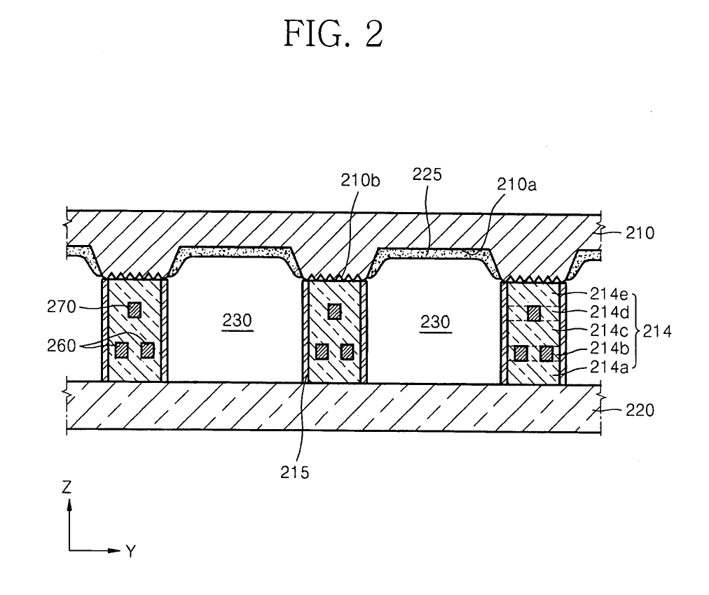

The barrier rib portions 214 of the electrode sheet 250 according to an embodiment of the present invention may be formed in any convenient shape as determined by one of ordinary skill in the art to have a plurality of volumetric structures therebetween to define the discharge cells 230, as illustrated in FIGS. 1-2. The barrier rib portions 214 may be formed of a dielectric material to facilitate induction and accumulation of wall charges.

The plurality of discharge cells 230 of the electrode sheet 250 according to an embodiment of the present invention may include a discharge gas, e.g., neon (Ne), xenon (Xe), or a mixture thereof, to accommodate proper plasma discharge. The discharge cells 230 may be formed between the barrier rib portions 214 to have any polygonal cross section as determined by one of ordinary skill in the art, e.g., cylindrical, triangular, pentagonal, elliptical, and so forth. In particular, the plurality of discharge cells 230 may be formed as a matrix, i.e., a plurality of rows and columns. The discharge cells 230 may correspond to the grooves 210a. For example, each discharge cell 230 may be positioned directly below a respective groove 210a, such that plasma discharge from each discharge cell 230 may be directed upward toward the respective groove 210a. Alternatively, each row, e.g., a line along the y-axis, of discharge cells 230 may be positioned directly below one respective groove 210a formed in parallel to the row of discharge cells 230, such that plasma discharge from all the discharge cell 230 in the row may reach the groove 210a.

The plurality of pairs of first and second discharge electrodes 260 and 270 of the electrode sheet 250 may be disposed in the electrode sheet 250, such that each of the first discharge electrodes 260 may be paired with a respective second discharge electrode 270 to generate a discharge in discharge cells 230 positioned therebetween. The plurality of pairs of first and second discharge electrodes 260 and 270 may serve as scan/sustain electrodes and address/sustain electrodes, e.g., first discharge electrodes 260 may operate as scan/sustain electrodes, and the second discharge electrodes 270 may operate as address/sustain electrodes, or vice versa.

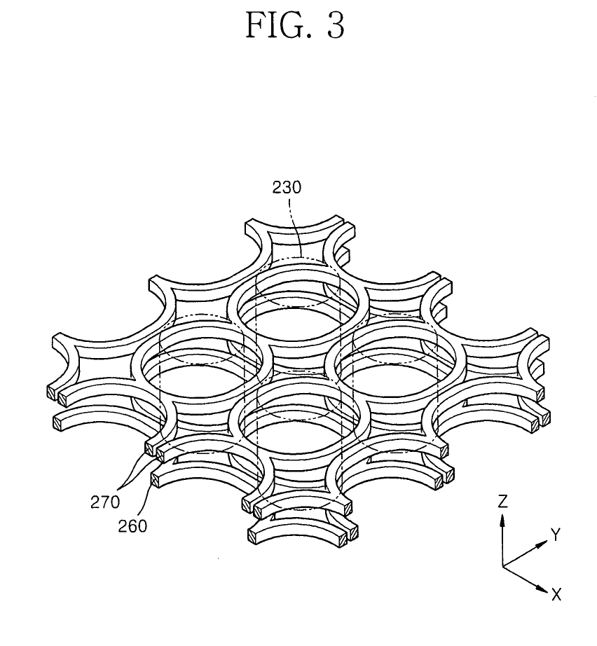

More specifically, as illustrated in FIG. 3, each of the first discharge electrodes 260 may include a plurality of tangential identical circles arranged sequentially into a single linear array along the x-axis, such that each circle of the plurality of circles may surround a single discharge cell 230. The plurality of first discharge electrodes 260 may be arranged parallel to one another, such that a small gap may be formed between every two first discharge electrodes 260. In this respect, it should be noted that “tangential circles” refer to circles that may touch one another at only one point, such that no other intersecting points may be formed between the circles, i.e., a cross-section along a tangent point of two circles may show a single point of contact.

Similarly, as further illustrated in FIG. 3, each of the second discharge electrodes 270 may include a plurality of tangential identical circles arranged sequentially into a single linear array along the y-axis, such that each second discharge electrode 270 may be positioned at a right angle to the plurality of first discharge electrodes 260. Each circle of the plurality of circles of each second discharge electrode 270 may be positioned above a respective circle of a respective first discharge electrode 260 to surround a discharge cell 230, such that each discharge cell 230 may be surrounded by two electrode circles. The plurality of second discharge electrodes 270 may be arranged parallel to one another, such that a small gap may be formed between every two second discharge electrodes 270. Additionally, a plane formed by the plurality of the second discharge electrodes 270 may be adjacent and parallel to a plane formed by the first discharge electrodes 260. Further, the planes of the first and second discharge electrodes 260 and 270 may have a gap therebetween along the z-axis, as illustrated in FIG. 3. The barrier rib portions 214 may prevent direct electrical conduction between the first and second discharge electrodes 260 and 270 and/or any potential damage thereto.

In this respect, it should be noted that even though the present embodiment, illustrated with respect to FIG. 3, includes identical circles, wherein the first discharge electrode 260 is positioned below the second discharge electrode 270, other configurations of electrode shapes and positions are not excluded from the scope of the present invention. For example, the plurality of the first discharge electrodes 260 may be positioned above the plurality of the second discharge electrodes 270.

The first and second discharge electrodes 260 and 270 may be formed of a conductive metal, e.g., aluminum, copper, and so forth.

Accordingly, and without intending to be bound by theory, it is believed that small voltage drops in the directions of the first and second discharge electrodes 260 and 270, i.e., x-axis and y-axis, may stabilize signal transmission.

The electrode sheet 250 of the PDP 200 according to an embodiment of the present invention may further include a plurality of protective layers 215. Each protective layer 215 may be formed of magnesium oxide (MgO) on a sidewall of a respective barrier rib 214. In particular, the protective layer 215 may be applied to each inner wall of the discharge cells 230, as illustrated in FIGS. 1-2. Accordingly, the plurality of protective layers 215 may minimize potential damage to the barrier rib portions 214 from plasma particles and reduce a discharge voltage by emitting secondary electrons.

The plurality of phosphor layers 225 of the PDP 200 according to an embodiment of the present invention may include red, green and blue phosphor layers disposed in the plurality of grooves 210a. In particular, each phosphor layer 225 may be disposed in a respective groove 210a of the first substrate 210, such that plasma discharge from the discharge cell 230 may reach the phosphor layer 225 in the groove 210a. The phosphor layers 225 may include any phosphorescent materials capable of generating visible light upon excitation by UV light. For example, the red light-emitting phosphor layers may include Y(V,P)O4:Eu, the green light-emitting phosphor layers may include Zn₂SiO₄: Mn and YBO₃: Tb, and the blue light-emitting phosphor layers may include BAM:Eu. Without intending to be bound by theory, it is believed that disposing the plurality of phosphor layers 225 in the grooves 210a may improve brightness and luminous efficiency of the PDP 200 because the grooves 210a may increase the size of the phosphor layers 225 employed.

According to another aspect of the present invention, an exemplary method of manufacturing the PDP 200 is as follows. First, the first and second substrates 210 and 220 may be prepared. Next, the first substrate 210 may be etched or sand-blasted to form the plurality of grooves 210a. Subsequently, the first substrate 210 may be sand-blasted to form the plurality of roughened portions 210b. Once the grooves 210a and the roughened portions 210b are formed, pastes of phosphor layers 225 may be applied to the grooves 210a of the first substrate 210, such that one phosphor layer 225 may be formed in each groove 210a, as described previously with respect to FIGS. 1-2. Subsequently, the paste in each groove 225 may be dried and fired to form the phosphor layers 225.

Next, the electrode sheet 250 may be manufactured by any convenient method as determined by one of ordinary skill in the art. For example, as illustrated in FIG. 2, a plurality of dielectric sheets may be prepared to form the barrier rib portions 214. In particular, the first and second discharge electrodes 260 and 270 may be formed in second and fourth dielectric sheets 214b and 214d, respectively. Next, first, third, and fifth dielectric sheets 214a, 214c and 214e may be formed. Subsequently, the first through fifth dielectric sheets 214a, 214b, 214c, 214d and 214e may be sequentially stacked, dried and fired to finalize formation of the barrier rib portions 214. The barrier rib portions 214 may be formed and arranged to have discharge cells 230 therebetween. Next, the protective layers 215 may be deposited onto the walls of the discharge cells 230 to finalize formation of the electrode sheet 250.

Once the first and second substrates 210 and 220 and the electrode sheet 250 are formed, the first substrate 210 and the second substrate 220 may be attached to one another with frit glass, such that the electrode sheet 250 may be positioned therebetween. Finally, an impure gas exhaustion/discharge gas injection process may be performed to complete manufacturing of the PDP 200.

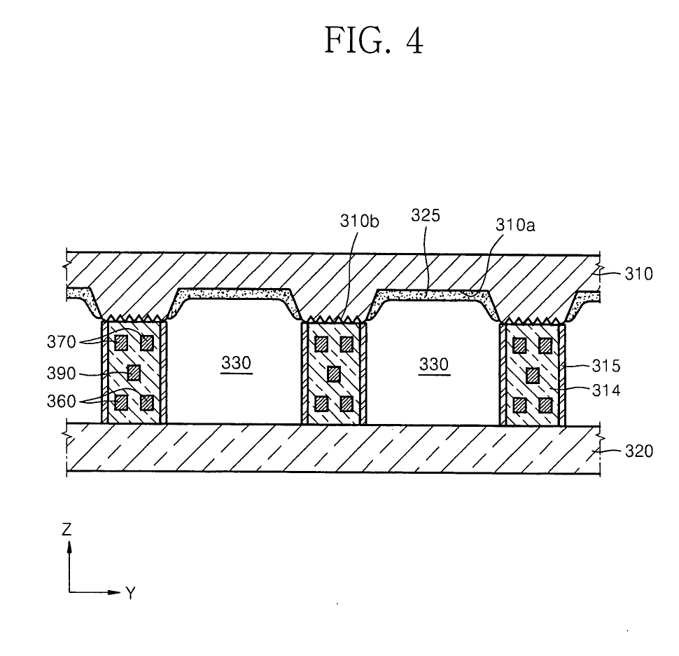

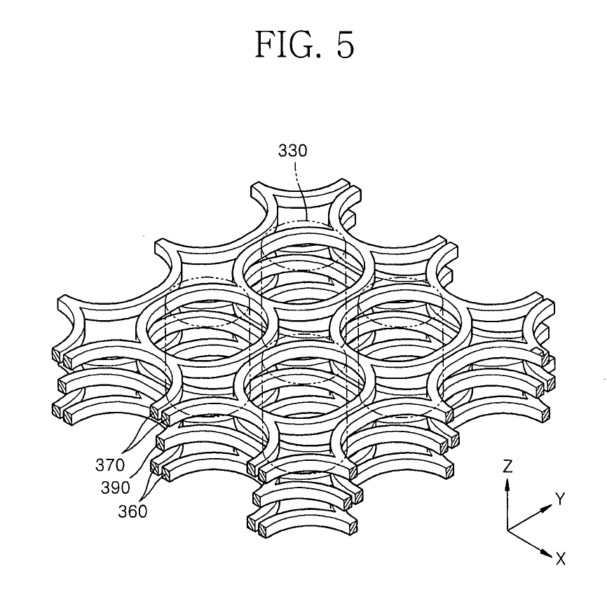

According to another embodiment of the present invention illustrated in FIGS. 4-5, a PDP 300 may be similar to the PDP 200 described with reference to FIGS. 1-3, with the exception that the PDP 300 may include a plurality of address electrodes 390.

In particular, the PDP 300 according to an embodiment of the present invention may include a first substrate 310 having grooves 310a and roughening portions 310b, a second substrate 320, an electrode sheet 350 having discharging cells 330 therein, and a plurality of phosphorescent layers 325. Further, the electrode sheet 350 of the PDP 300 of the present invention may include a plurality of barrier rib portions 314, a plurality of discharge cells 330, a plurality of pairs of first and second discharge electrodes 360 and 370, respectively, a plurality of protective layers 315, and a plurality of address electrodes 390.

It is noted that the particular elements included in the embodiment illustrated in FIGS. 4-5 and their operation is similar to the description provided previously with respect to the PDP 200 illustrated in FIGS. 1-3. Accordingly, only details that may be distinguishable from the previous embodiment will be described hereinafter. It is further noted that reference numerals having identical last two digits refer to like elements and the first digits “2” and “3” are employed only for the purpose of distinguishing embodiments and not elements.

As illustrated in FIG. 5, each of the first and second discharge electrodes 360 and 370 may include a plurality of tangential identical circles arranged sequentially into linear arrays along the x-axis, such that each circle of the plurality of circles may surround a single discharge cell 330. The plurality of first and second discharge electrodes 360 and 370 may be arranged similarly to the configuration described previously with respect to FIGS. 1-3. The plurality of pairs of first and second discharge electrodes 360 and 370 may serve as scan and sustain electrodes respectively. However, other electrode configurations are not excluded from the scope of the present invention.

As further illustrated in FIG. 5, each of the plurality of the address electrodes 390 may include a plurality of tangential identical circles arranged sequentially into a single linear array along the y-axis, such that each address electrodes 390 may be positioned at a right angle to the plurality of first and second discharge electrodes 360 and 370. Each circle of the plurality of circles of each address electrodes 390 may be positioned between respective circles of respective first and second discharge electrode 360 and 370 to surround a discharge cell 330, such that each discharge cell 330 may be surrounded by three concentric circles. The plurality of address electrodes 390 may be arranged parallel to one another, such that a small gap may be formed between every two address electrodes 390. Additionally, a plane formed by the address electrodes 390 may be parallel to, i.e., positioned in the xy-plane, and positioned between the planes formed by the first and second discharge electrodes 360 and 370.

In this respect, it should be noted that even though the present embodiment, illustrated with respect to FIGS. 4-5, includes identical circles, wherein the address electrodes 390 are positioned between the first and second discharge electrodes 260 and 270, other configurations of electrode shapes and positions are not excluded from the scope of the present invention. For example, the address electrodes 390 may be positioned adjacent to the first substrate 310, on the second substrate 320, and so forth.

Formation of the plurality of address electrodes 390 according to an embodiment of the present invention may facilitate generation of an address discharge to produce a sustain discharge between the first and second discharge electrodes 360 and 370 and, thereby, to reduce an initial voltage of a sustain discharge.

According to another aspect of the present invention, an exemplary method of driving the PDP 200 illustrated in FIGS. 1-3 is as follows. First, address discharge may be generated between the first and second discharge electrodes 260 to select discharge cells 230 to be operated. Next, alternating current (AC) sustain voltage may be applied between the first and second discharge electrodes 260 and 270 of the selected discharge cells 230 to generate a sustain discharge and, subsequently, UV light emission therein. In this respect it should be noted that the sustain discharge may occur in the entire volumetric space defining each of the discharge cells 230. Subsequently, the UV light may be emitted upward toward the first substrate 210 to excite the plurality of phosphor layers 225 thereon. Excitation of the phosphor layers 225 may emit visible light to form images.

Without intending to be bound by theory, it is believed that the inventive structure of the PDP 200 and the driving method thereof is advantageous because the sustain discharge in the PDP 200 occurs on all sides of the barrier rib portions 214, as opposed to a conventional PDP having a sustain discharge on the first substrate in a horizontal direction only. The sustain discharge in the present invention may diffuse toward center portions of the discharge cells 230 and increase the discharge area and volume as compared to the conventional PDP. It should further be noted that the occurrence of sustain discharge in the central portions of the discharge cells 230 may reduce ion sputtering of phosphor, thereby minimizing burning of permanent images into the PDP.

According to another aspect of the present invention, an exemplary method of driving the PDP 300 illustrated in FIGS. 4-5 is as follows. First, an address discharge may be generated between the first discharge electrodes 360 and the address electrodes 390 to select discharge cells 230 to be operated. Next, alternating current (AC) sustain voltage may be applied between the first and second discharge electrodes 260 and 270 of the selected discharge cells 230 to generate a sustain discharge and, subsequently, UV light emission therein. In this respect it should be noted that the sustain discharge may occur in the entire volumetric space defining each of the discharge cells 230. Subsequently, the UV light may be emitted upward toward the first substrate 210 to excite the plurality of phosphor layers 225 thereon. Excitation of the phosphor layers 225 may emit visible light to form images.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A plasma display panel (PDP), comprising:
a first substrate having a plurality of roughened portions;
a second substrate spaced apart from the first substrate;
a plurality of barrier ribs dividing a space between the first substrate and the second substrate into a plurality of discharge cells, the barrier ribs positioned between the second substrate and a respective roughened portion of the first substrate; and
a plurality of first and second discharge electrodes disposed inside the electrode sheet.

2. The PDP as claimed in claim 1, wherein the first substrate includes a plurality of grooves, each groove positioned between two adjacent roughened portions.

3. The PDP as claimed in claim 2, further comprising a plurality of phosphor layers on a surface of a respective groove.

4. The PDP as claimed in claim 3, wherein each phosphor layer is disposed on a surface of a respective groove.

5. The PDP as claimed in claim 4, wherein each phosphor layer is positioned between a respective discharge cell and a respective groove.

6. The PDP as claimed in claim 1, wherein each of the plurality of first and second discharge electrodes comprises a plurality of shapes surrounding each of the discharge cells.

7. The PDP as claimed in claim 6, wherein each of the plurality of the first discharge electrodes extends in parallel to one another and each of the plurality of the second discharge electrodes extends in parallel to one another, the plurality of first discharge electrodes being positioned on a plane parallel to a plane of the second discharge electrodes.

8. The PDP as claimed in claim 7, wherein each of the plurality of shapes surrounding each of the discharge cells is a circle.

9. The PDP as claimed in claim 7, wherein each of the plurality of the first discharge electrodes crosses each of the plurality of the second discharge electrodes.

10. The PDP as claimed in claim 7, wherein each of the plurality of the first discharge electrodes is parallel to each of the plurality of the second discharge electrodes.

11. The PDP as claimed in claim 10, further comprising a plurality of address electrodes crossing the first discharge electrodes.

12. The PDP as claimed in claim 1, wherein the roughened portions are parallel to the barrier rib portions.

13. The PDP as claimed in claim 1, wherein the barrier rib portions include a dielectric material.
